(19) United States
(12) Patent Application Publication
(10) Pub. No.: US 2004/0019697 A1
(43) Pub. Date: Jan. 29, 2004

(54) Method and system for correcting the spelling of incorrectly spelled uniform resource locators using closest alphabetical match technique

(76) Inventor: Chris Rose, Miami, FL (US)

Correspondence Address: LERNER AND GREENBERG, P.A., POST OFFICE BOX 2480, HOLLYWOOD, FL, 33022-2480, US

(21) Appl. No.: 10/190,122

(22) Filed: Jul. 3, 2002

(51) Int. Cl. G06F 15/16

(52) U.S. Cl. 709/245; 709/218

(57) ABSTRACT

A method for identifying correct uniform resource locators from incorrectly spelled uniform resource locators using closest alphabetical match technique includes the steps of typing a uniform resource locator address into a web browser, querying, with the browser, a domain name server for a corresponding web page, receiving an invalid response with the web browser, requesting, through the web browser, the domain name server to perform a closest alphabetical match search to find an entry/name in a DNS table alphabetically closest to the typed-in URL address and to provide back to the browser that address and a range of immediately surrounding addresses, and displaying results of the closest alphabetical match search with the browser. A computer readable storage medium containing program instructions for performing the method and a system for identifying the correct URLs is also provided.

### BACKGROUND OF THE INVENTION

### FIELD OF THE INVENTION

The present invention lies in the field of computers and computer systems and, particularly, to a method and system for use on the world wide web, Internet, and other sources of information and for utilization of existing equipment advantageously for providing interactive web server data access over networks and the internet.

A web browser is a program running on a computer that acts as an Internet tour guide, complete with pictorial desktops, directories, and search tools used when a user “surfs” the Internet. As used herein, the web browser is used by a client to communicate with the World Wide Web.

A domain is a computer, a group of computers, or groups of computers and devices on a network that are administered as a unit with common rules and procedures. Examples of domain names include www.cnn.com, www.yahoo.com, www.bbc.co.uk, and www.barry.edu.

Humans are extremely good at remembering words, such as domain names, but are not as good at remembering strings of numbers. Names that are easy for people to remember, however, are not helpful to a computer because a computer does not understand words. On the contrary, computers can process, and, thus, understand, numbers. For this reason, domain names are assigned words for identification by humans and numbers for identification by computers.

Each computer or device connected to the Internet is assigned a unique address called an Internet Protocol (IP) address. These IP addresses are currently 32-bit numbers (but are being transitioned to 128-bit numbers in IPv6) and are normally expressed as 4 octets as a dotted decimal number. A typical IP address might look like: 123.123.12.123.

The domain name server (DNS) system is a technique of translating domain names to IP addresses. It is a hierarchical, tree-structured system having a top that is given the name “root”. At the root, there are several hundred top-level domain names, including COM, EDU, GOV, MIL, NET, ORG, BIZ, INFO, and NAME. Further, there are unique two-letter combinations for a country, such as UK for the United Kingdom and JM for Jamaica.

A DNS system maintains a list of domain names that correspond to the IP addresses. Every time someone uses a domain name, the Internet's domain name servers translate the human-readable domain name into a computer-readable IP address. Therefore, during each event of web browsing and e-mailing, the user might access the domain name servers several times.

Within every top-level domain, there is a huge list of second-level domains. For example, most commercial businesses have a domain name that ends in “COM”. Thus, millions of domains end in “COM”, but every name in the COM top-level is a second-level domain and is unique. For example, “yahoo”, “cnn”, and “amazon” are all second-level domains within the COM top-level domain.

On the Internet, a computer needs an IP address to connect to another computer. While users typically type a domain name to access a given domain, the user can also type the numeric IP address directly into the web-browser to reach that domain. Therefore, typing the uniform resource locator http://123.123.12.123 will take the user to the corresponding domain of that IP address (if one exists).

Because all names in a domain are unique, only one entity controls the master list of all the names in that domain and makes sure that the list is updated and that there are no duplicates. For example, Network Solutions maintains the current list for the COM top-level domain. Because Network Solutions is the central authority keeping track of the COM list, each registrar that registers domain names works with Network Solutions to add names to the central list. But, the database of top-level domain names is not centralized. Many companies have thousands of IP addresses and most countries want to administer their own country domain, such as JP for Japan or UK for the United Kingdom.

The DNS system is a distributed database system, which means that every element can be responsible for its own part of the system. Every domain has a domain name server that handles the requests to translate domain names to IP address requests, and the process is completely distributed throughout the world on millions of machines maintained by millions of persons. Yet, it behaves like a single, integrated database.

When a user types a uniform resource locator (URL) into a browser, the browser first alphabetically matches the URL with the first entries/names in a central list. The browser then converts the matching domain name into an IP address, so that the browser can request a web page from the machine at that IP address. To perform a request, the browser contacts the DNS system and requests the conversion. The closest domain server may already have the IP address requested, and, if it does, it immediately sends the information back to the user's browser.

However, if the DNS does not know the IP address, it can contact other name servers, including one or more of the root name servers, which have all of the IP addresses for a particular top-level domain. Multiple name servers exist at every level. These name servers constantly update one another. Consequently, there is redundancy built into the system.

A DNS usually only performs two functions:

1) accept requests from programs to convert domain names into IP addresses; and

2) accept requests from other name servers to convert domain names into IP addresses.

Upon receiving a request, the DNS can do one of four things:

1) answer the request with an IP address because the DNS already knows the IP address for the domain;

2) contact another DNS and try to find the IP address for the name requested;

3) respond that it does not know the IP address, but can give the IP address for another DNS that knows more; and/or

4) return an error message because the requested domain name is invalid or does not exist.

Because of such error messages, surfing the Internet is still a time-consuming affair. This is particularly true when the user types an incorrectly spelled URL into the browser. The user receives a response that the page cannot be displayed or the browser is unable to locate the server. This and other difficulties are solved by the present invention.

### SUMMARY OF THE INVENTION

It is accordingly an object of the invention to provide a method and system for correcting the spelling of incorrectly spelled uniform resource locators using closest alphabetical match technique that overcome the hereinafore-mentioned disadvantages of the heretofore-known devices and methods of this general type and that provide a list of usable domain names when a user types an incorrectly spelled or invalid URL into the browser.

With the foregoing and other objects in view, there is provided, in accordance with the invention, a method for identifying correct URLs from one of incorrectly spelled and invalid URLs using closest alphabetical matching including the step of typing in a URL address into a web browser. A browser queries a DNS for an IP address to a web page corresponding to the typed-in URL address. The browser receives a response from the DNS, the response indicating that the typed-in URL address is invalid. The browser sends a request to the DNS to perform a closest alphabetical match search to find a URL address in a DNS database alphabetically closest to the typed-in URL address and to provide back to the browser the alphabetically closest URL address and a range of URL addresses surrounding the alphabetically closest URL address. The DNS locates a URL address in the DNS database alphabetically closest to the typed-in URL address. The DNS identifies a range of URL addresses surrounding the alphabetically closest URL address. The DNS provides to the browser the alphabetically closest URL address and the range of URL addresses surrounding the alphabetically closest URL address. Finally, results of the DNS search are displayed to the user through the browser.

The present invention provides a method and system to retrieve the correct URL by comparing all the listings on an implementation of the Domain Name System protocols. The invention also includes a DNS presenting a list of similar URLs with similar spellings from which a user can select the web site that she wishes to retrieve.

The term “alphabetically” is defined herein as not only including the alphabet, but also including all other alphanumeric characters that can be submitted from a computer, including numbers, letters, and symbols. Thus, when a process of searching alphabetically is mentioned, this refers to an alphanumeric ordering of all characters/symbols as performed in general practice for alphabetically ordering items in a computer database.

In accordance with another mode of the invention, the locating step is performed by alphabetically searching the DNS database for a URL address that matches a greatest number of initial string characters of the typed-in URL address.

In accordance with a further mode of the invention, the locating step is performed by alphabetically searching the DNS database for a URL address that matches an initial string of characters of the typed-in URL address iteratively for each character of the typed-in URL address and locating the alphabetically closest URL address to the typed-in URL address by identifying a particular URL address having a greatest number of identical initial characters to the initial string of characters.

In accordance with an added mode of the invention, the locating step is performed by determining a number of characters in the typed-in URL address, initializing a counter value to 1, alphabetically searching the DNS database for a first URL address matching an initial string of characters of the typed-in URLI address, the initial string having a character length equal to the counter value, if a first matching URL address exists in the DNS database, then storing, in a memory, the first matching URL address, incrementing the counter value by 1, repeating the searching, storing, and incrementing steps until a first matching URL address does not exist in the DNS database, and, if a first matching URL address does not exist in the DNS database, then defining the alphabetically closest URL address as the last URL address stored in the memory.

In accordance with an additional mode of the invention, the range identifying step is performed by storing a first given number of URL addresses immediately alphabetically preceding the alphabetically closest URL address in the DNS database, and storing, in alphabetical order, a second given number of URL addresses immediately alphabetically succeeding the alphabetically closest URL address in the DNS database.

In accordance with yet another mode of the invention, the displaying step is carried out by displaying the first given number of URL addresses, the alphabetically closest URL address, and the second given number of URL addresses all in alphabetical order, preferably, all as hyperlinks in alphabetical order.

In accordance with yet a further mode of the invention, results of the DNS search are displayed to the user in hyperlinked form.

In accordance with yet an added mode of the invention, one of the URL addresses are selected from the closest URL address and the range of URL addresses and a web site corresponding to the one selected URL address is accessed.

With the objects of the invention in view, there is also provided a method for identifying correct uniform resource locators from one of incorrectly spelled and invalid URLs sent from a web browser to a domain name server using closest alphabetical matching including the steps of receiving in the browser a response from the DNS, the response indicating that a URL address typed in by a user is invalid and sending, from the browser, a request to the DNS to perform a closest alphabetical match search to find a URL address in a DNS database alphabetically closest to the typed-in URL address.

With the objects of the invention in view, there is also provided a system for identifying correct uniform resource locators from one of incorrectly spelled and invalid URLs sent from a web browser through an interconnecting network to a domain name server using closest alphabetical matching, including means for rcceiving in the browser a response from the DNS, the response indicating that a URL address typed in by a user is invalid and means for sending, from the browser, a request to the DNS to perform a closest alphabetical match search to find a URL address in a DNS database alphabetically closest to the typed-in URL address.

In accordance with yet an additional feature of the invention, there are provided means for providing back to the browser a URL address alphabetically closest to the typed-in URL address and a range of URL addresses surrounding the alphabetically closest URL address, means for locating, with the DNS, the alphabetically closest URL address in the DNS database, means for identifying, with the DNS, a range of URL addresses surrounding the alphabetically closest URL address, means for providing, from the DNS to the browser, the alphabetically closest URL address and the range of URL addresses surrounding the alphabetically closest URL address, and means for displaying the alphabetically closest URL address and the range of URL addresses to the user through the browser.

In accordance with again another feature of the invention, the locating means is a means for alphabetically searching the DNS database for a URL address that matches a greatest number of initial string characters of the typed-in URL address.

With the objects of the invention in view, there is also provided a computer readable storage medium containing program instructions for performing a method for identifying correct uniform resource locators from one of incorrectly spelled and invalid URLs sent from a web browser to a domain name server using closest alphabetical matching including the steps of receiving in the browser a response from the DNS, the response indicating that the URL address is invalid and sending, from the browser, a request to the DNS to perform a closest alphabetical match search to find a URL address in a DNS database alphabetically closest to the typed-in URL address.

In accordance with again a further mode of the invention, the DNS locates the URL address in the DNS database alphabetically closest~to the typed-in URL address, the DNS identifies a range of URL addresses surrounding the alphabetically closest URL address, the DNS provides to the browser the alphabetically closest URL address and the range of URL addresses, and the results of the DNS search are displayed to the user through the browser.

In accordance with a concomitant mode of the invention, the locating step is performed by alphabetically searching the DNS database for a URL address that matches a greatest number of initial string characters of the typed-in URL address.

Other features that are considered as characteristic for the invention are set forth in the appended claims.

Although the invention is illustrated and described herein as embodied in a method and system for correcting the spelling of incorrectly spelled uniform resource locators using closest alphabetical match technique, it is, nevertheless, not intended to be limited to the details shown because various modifications and structural changes may be made therein without departing from the spirit of the invention and within the scope and range of equivalents of the claims.

The construction and method of operation of the invention, however, together with additional objects and advantages thereof, will be best understood from the following description of specific embodiments when read in connection with the accompanying drawings.

### BRIEF DESCRIPTION OF THE DRAWINGS

FIG. 1 is a diagrammatic overview of a distributed computer system having internal and external networks including the Internet to connect clients to World Wide Web servers and other servers within the system, the present invention being situated in a user's computer;

FIG. 2 is a flow chart of a prior art method for processing invalid or misspelled user URL requests;

FIG. 3 is a flow chart for processing invalid or misspelled user URL requests according to the invention; and

FIG. 4 is a flow chart for alphabetically searching for closest URL addresses to a typed-in URL address according to the invention.

### DESCRIPTION OF THE PREFERRED EMBODIMENTS

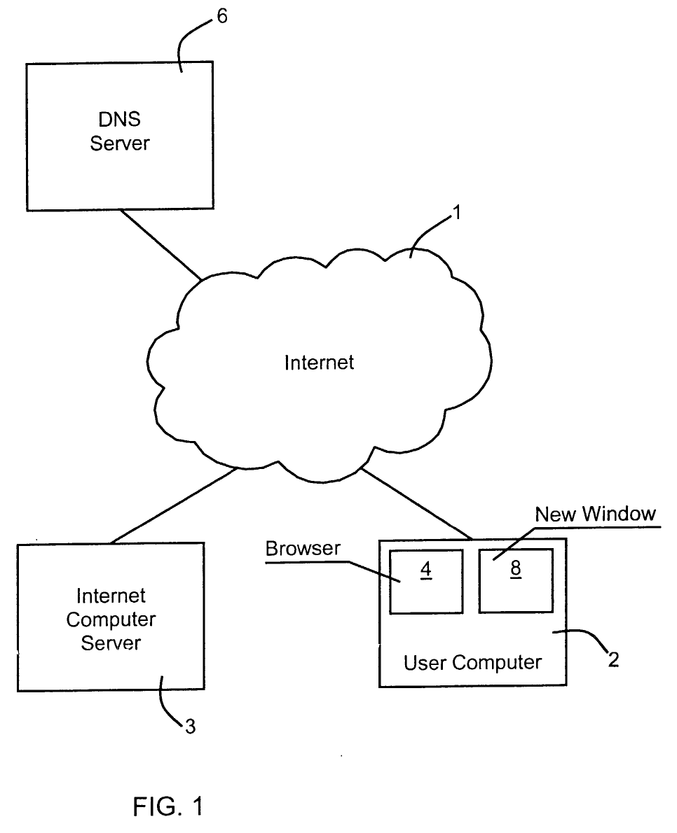

Referring now to the figures of the drawings in detail and first, particularly to FIG. 1 thereof, there is shown a globally based telecommunications network, the “Internet”. A function of the Internet is to provide an infrastructure that supports wired and wireless digital telecommunications throughout the world using the well-known TCP/IP networking protocols. The Internet infrastructure includes Internet Service Providers (ISPs), Network Service Providers (NSPs), routers, telecommunication lines and channels, etc., all well known in the art.

As shown in FIG. 1, many Internet web-site servers (i.e., server computer systems) 3 physically located throughout the world are connected to the Internet 1 by way of the Internet infrastructure (i.e., ISPs and NSPs). As the name implies, a function of an Internet computer server 3 is to serve information resources to Internet users when requested to do so by a client computer system 2. A uniform resource locator, the syntax of which is well known in the art, specifies the location of each and every information resource on an information server connected to the Internet infrastructure.

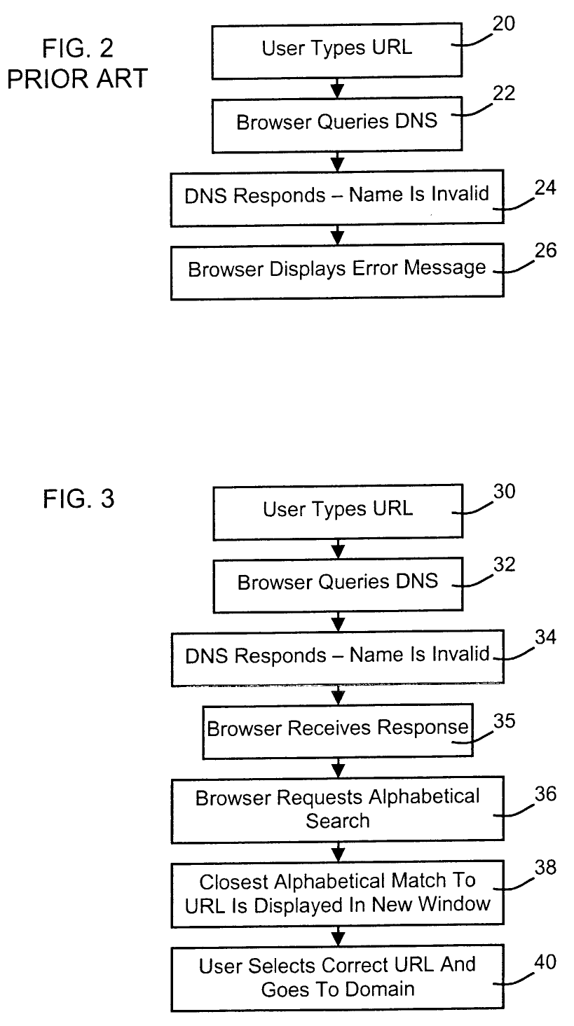

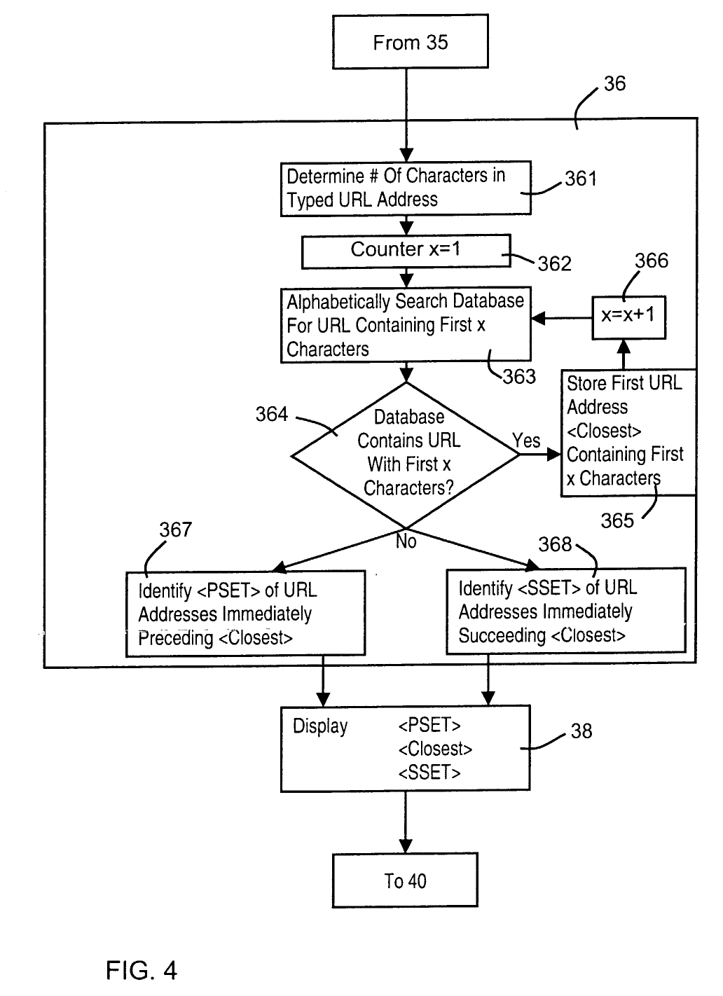

FIG. 2 describes the conventional way browsers responded to users who misspelled a URL or typed-in a non-existent URL. In step 20, a user at a client computer 2 types a URL address into the web browser 4. The typed-in URL address is either misspelled or is invalid. In step 22, the browser 4 queries the DNS 6 with the typed-in URL address. In step 24, the DNS 6 responds that the typed-in address is invalid. In step 26, the browser 4 displays an error message.

Because there are many invalid URL addresses and due to the fact that users constantly misspell URL addresses, DNSs often return error messages. Prior to the invention, if a user typed an incorrect URL into the browser, the browser simply responded to the user with a message such as “cannot open page”, “server cannot be found”, or some other similar message depending on the type of browser used. In the conventional system, therefore, the user is left with no clue as to why the typed URL address generated the invalid error message.

Based upon the knowledge that the DNS system contains a central list of all of the domains, the present invention provides information to the user instead of leaving the user guessing. Using the invention, the DNS system can now provide the user with a potential match between the name actually typed in and, therefore, the correct IP address sought by the user. The invention makes use of the DNS system's ability to search its own list and provide the closest alphabetical match to the URL that was typed into the browser.

The process of the invention is described with respect to FIG. 3. In step 30, a user at the client computer 2 types a URL address into the web browser 4. The typed-in URL address is either misspelled or is invalid. In step 32, the browser 4 queries the DNS 6 for the corresponding web page to the typed URL address. In step 34, the DNS 6 responds to the browser 4 that the typed-in address is invalid, which response is received by the browser 4 in step 35. In contrast to providing merely an error message, in step 36 the browser 4 requests the DNS 6 to perform an alphabetical search as further described in the following text. After receiving results of the search, in steps 38 and 40, the DNS 6 provides to the browser 4 a URL address that is alphabetically closest to the typed-in URL address an a list of other URL addresses immediately alphabetically preceding and succeeding the alphabetically closest URL address. The browser then displays the results of the DNS search in a new window 8 to the user.

Various steps are taken for requesting the DNS 6 to perform an alphabetical search.

First, in step 361, the browser 4, or another program resident on the client computer 2, counts the number of characters in the typed-in URL address. A character can be any alphanumeric character that can be submitted from a computer, including numbers, letters, and symbols.

In step 362, a counter X is set to 1. The counter X is, preferably, an integer counter.

In step 363, the DNS 6 is asked if the database contains a URL address beginning with the first X character(s) of the typed-in URL address. It is noted that where counter X is equal to 1, substantially all DNSs 6 will have a URL address beginning with any first character of a typed-in URL address.

Therefore, the counter X can, optionally, be initially set to 2, or can be set to any integer greater than 2, whether manually or automatically.

In step 364, the DNS 6 responds with an answer as to whether or not the DNS database contains a URL address beginning with the first X character(s) of the typed-in URL address.

If the answer is yes, in step 365, the first URL address containing the first X character(s) is stored in a memory and, in step 366, the counter X is incremented by 1. This first URL address is referred to herein as the variable <closest>.

The search request to the DNS 6 in step 363 is then repeated.

For every subsequent time that the DNS 6 indicates the database contains a URL address beginning with the first X characters of the typed URL address, a new <closest> URL address is stored and the counter X is incremented. This sub-process is repeated until the DNS responds that the database does not contain a URL address beginning with the first X character(s) of the typed URL address. The process of looking up a typed-in URL address character-by-character is referred to herein as parsing the typed-in URL address.

In summary, an alphabetical search of the database is performed sequentially (i.e., character by character) until there is an indication that the DNS list does not contain a domain name including all previously matched parsed characters plus the current, i.e., last, parsed character.

At some point, the answer to the query will be no, at which point, the variable <closest>is a URL address that is the closest to the spelling of the first X-1 characters of the typed URL address, in other words, it is the alphabetically closest URL address to the typed-in URL address.

In step 367, the DNS 6 is then asked to produce a first list <pset> of a first given number of URL addresses immediately preceding (in alphabetical order) the URL address corresponding to <closest>. The first given number can be any size, preferably, however, the number is four or five.

Simultaneously or subsequently, in step 368, the DNS 6 is asked to produce a second list <sset> of a second given number of URL addresses immediately succeeding (in alphabetical order) the URL address corresponding to <closest>. The second given number can be any size, preferably, however, the number is four or five.

Finally, in step 38, the browser displays <pset>, <closest>, and <sset> to the user. Preferably, the entries of <pset>, <closest>, and <sset> are displayed vertically, in alphabetical order with <closest>highlighted, or otherwise identified, in the middle.

The invention, therefore, provides a possible way of matching existing URL addresses to a misspelled or invalid URL address typed in by a user. Because the DNS will most likely be requested to display the results of the search to the user in hyperlinked fashion, the invention provides users with easy access of web sites associated with URL addresses that most closely match the typed-in, albeit, misspelled or invalid, URL address.

A specific illustration of the method according to the invention can be made using the word entries of Webster's II New Riverside University dictionary as an example central list. In such an example, when a user, intending to type “www.placebo.com” accidentally types in “www.placebu.com”, the list output to the user according to the invention will be as follows, where ±4 entries are displayed:

www.placable.com

www.placard.com

www.placate.com

www.place.com

www.placebo.com

www.placekick.com

www.placemat.com

www.placement.com

www.placenta.com.

Using the same parameters as the example above, if a user, instead, types “www.plecebo.com”, the list supplied to the user will be as follows:

www.plebe.com

www.plebeian.com

www.plebes.com

www.plebiscite.com

www.plebs.com

www.plecopteran.com

www.plectognath.com

www.plectrum.com

www.pled.com

In step 40, the user may select the correctly named URL and access the web site or can type in a new URL address if the match is not close to that which was desired or intended.

Thus, the present invention advantageously seeks to search the DNS system and provide the closest alphabetical match to the name that was actually typed in by the user. The present invention also seeks to display the results in a new window with the retrieved URLs hyperlinked, so that the user can simply select the correct hyperlink for the name that was misspelled.

I claim:

1. A method for identifying correct URLs from one of incorrectly spelled and invalid URLs using closest alphabetical matching, which comprises:
typing in a URL address into a web browser;
querying, with the browser, a DNS for an Internet protocol address to a web page corresponding to the typed-in URL address;
receiving in the browser a response from the DNS, the response indicating that the typed-in URL address is invalid;
sending, from the browser, a request to the DNS to perform a closest alphabetical match search to find a URL address in a DNS database alphabetically closest to the typed-in URL address and to provide back to the browser the alphabetically closest URL address and a range of URL addresses surrounding the alphabetically closest URL address;
locating, with the DNS, a URL address in the DNS database alphabetically closest to the typed-in URL address;
identifying, with the DNS, a range of URL addresses surrounding the alphabetically closest URL address;
providing, from the DNS to the browser, the alphabetically closest URL address and the range of URL addresses; and
displaying results of the DNS search to the user through the browser.

2. The method according to claim 1, which further comprises performing the locating step by alphabetically searching the DNS database for a URL address that matches a greatest number of initial string characters of the typed-in URL address.

3. The method according to claim 1, which further comprises performing the locating step by:
alphabetically searching the DNS database for a URL address that matches an initial string of characters of the typed-in URL address iteratively for each character of the typed-in URL address; and
locating the alphabetically closest URL address to the typed-in URL address by identifying a particular URL address having a greatest number of identical initial characters to the initial string of characters.

4. The method according to claim 1, which further comprises performing the locating step by:
determining a number of characters in the typed-in URL address;
initializing a counter value to 1;
alphabetically searching the DNS database for a first URL address matching an initial string of characters of the typed-in URL address, the initial string having a character length equal to the counter value;
if a first matching URL address exists in the DNS database, then:
storing, in a memory, the first matching URL address;
incrementing the counter value by 1;
repeating the searching, storing, and incrementing steps until a first matching URL address does not exist in the DNS database; and
if a first matching URL address does not exist in the DNS database, then, defining the alphabetically closest URL address as the last URL address stored in the memory.

5. The method according to claim 4, which further comprises performing the range identifying step by:
storing a first given number of URL addresses immediately alphabetically preceding the alphabetically closest URL address in the DNS database; and
storing, in alphabetical order, a second given number of URL addresses immediately alphabetically succeeding the alphabetically closest URL address in the DNS database.

6. The method according to claim 5, which further comprises carrying out the displaying step by displaying the first given number of URL addresses, the alphabetically closest URL address, and the second given number of URL addresses all in alphabetical order.

7. The method according to claim 6, which further comprises carrying out the displaying step by displaying the first given number of URL addresses, the alphabetically closest URL address, and the second given number of URL addresses all as hyperlinks in alphabetical order.

8. The method according to claim 1, which further comprises displaying results of the DNS search to the user in hyperlinked form.

9. The method according to claim 1, which further comprises:
selecting one of the URL addresses from the closest URL address and the range of URL addresses; and
accessing a web site corresponding to the one selected URL address.

10. A method for identifying correct uniform resource locators from one of incorrectly spelled and invalid URLs sent from a web browser to a domain name server using closest alphabetical matching, which comprises:
receiving in the browser a response from the DNS, the response indicating that a URL address typed in by a user is invalid; and
sending, from the browser, a request to the DNS to perform a closest alphabetical match search to find a URL address in a DNS database alphabetically closest to the typed-in URL address.

11. The method according to claim 10, which further comprises sending, from the browser, a request to the DNS to provide back a URL address alphabetically closest to the typed-in URL address and a range of URL addresses surrounding the alphabetically closest URL address.

12. The method according to claim 10, which further comprises locating, with the DNS, the URL address in the DNS database alphabetically closest to the typed-in URL address.

13. The method according to claim 10, which further comprises identifying, with the DNS, a range of URL addresses surrounding the alphabetically closest URL address.

14. The method according to claim 10, which further comprises providing, from the DNS to the browser, the URL address in the DNS database alphabetically closest to the typed-in URL address and the range of URL addresses surrounding the alphabetically closest URL address.

15. The method according to claim 10, which further comprises displaying results of the DNS search to the user through the browser.

16. A system for identifying correct uniform resource locators from one of incorrectly spelled and invalid URLs sent from a web browser through an interconnecting network to a domain name server using closest alphabetical matching, which comprises:
means for receiving in the browser a response from the DNS, the response indicating that a URL address typed in by a user is invalid; and
means for sending, from the browser, a request to the DNS to perform a closest alphabetical match search to find a URL address in a DNS database alphabetically closest to the typed-in URL address.

17. The system according to claim 16, including:
means for providing back to the browser a URL address alphabetically closest to the typed-in URL address and a range of URL addresses surrounding the alphabetically closest URL address;
means for locating, with the DNS, the alphabetically closest URL address in the DNS database;
means for identifying, with the DNS, a range of URL addresses surrounding the alphabetically closest URL address;
means for providing, from the DNS to the browser, the alphabetically closest URL address and the range of URL addresses surrounding the alphabetically closest URL address; and
means for displaying the alphabetically closest URL address and the range of URL addresses to the user through the browser.

18. The system according to claim 17, wherein said means for locating is a means for alphabetically searching the DNS database for a URL address that matches a greatest number of initial string characters of the typed-in URL address.

19. A computer readable storage medium containing program instructions for performing a method for identifying correct uniform resource locators from one of incorrectly spelled and invalid URLs sent from a web browser to a domain name server using closest alphabetical matching, which comprises:
receiving in the browser a response from the DNS, the response indicating that the URL address is invalid; and
sending, from the browser, a request to the DNS to perform a closest alphabetical match search to find a URL address in a DNS database alphabetically closest to the typed-in URL address.

20. The computer readable storage medium containing program instructions for performing a method according to claim 19, which further comprises:
locating, with the DNS, the URL address in the DNS database alphabetically closest to the typed-in URL address;
identifying, with the DNS, a range of URL addresses surrounding the alphabetically closest URL address;
providing, from the DNS to the browser, the alphabetically closest URL address and the range of URL addresses; and
displaying results of the DNS search to the user through the browser.

21. The computer readable storage medium containing program instructions for performing a method according to claim 19, which further comprises performing the locating step by alphabetically searching the DNS database for a URL address. that matches a greatest number of initial string characters of the typed-in URL address.
